(19) United States
(12) Patent Application Publication
(10) Pub. No.: US 2014/0220535 A1
(43) Pub. Date: Aug. 7, 2014

(54) METHODS, SYSTEMS, AND COMPUTER READABLE MEDIA FOR TAGGING ATOMIC LEARNING UNITS OF INSTRUCTIONAL CONTENT WITH STANDARDS AND LEVELS OF RIGOR AND FOR USING THE TAGGED ATOMIC LEARNING UNITS FOR DYNAMICALLY GENERATING A CURRICULUM FOR INDIVIDUALIZED ACADEMIC INSTRUCTION

(71) Applicant: VSCHOOLZ, INC., Coral Springs, FL (US)

(72) Inventor: Caterina Trimm Angelone, Coral Springs, FL (US)

(73) Assignee: VSCHOOLZ, INC., Coral Springs, FL (US)

(21) Appl. No.: 13/759,881

(22) Filed: Feb. 5, 2013

(51) Int. Cl. G09B 5/00

(52) U.S. Cl. CPC G09B 5/00
USPC 434/350

(57) ABSTRACT

A system for tagging atomic learning units of instructional content and for dynamically generating a curriculum tailored to an individual using the tagged units is disclosed. The system includes a tagging module for tagging atomic learning units of instructional content with at least one standard and at least one level of rigor to form learning objects. The system further includes a learning objects database for storing the learning objects. The system further includes a dynamic curriculum generation module for dynamically generating a curriculum tailored to an individual by selecting individual learning objects from the database using the tags and for presenting the curriculum to the individual.

### TECHNICAL FIELD

The subject matter described herein relates to dynamic generation of an individualized academic instruction program. More particularly, the subject matter described herein relates to methods, systems, and computer readable media for tagging atomic learning units of instructional content with standards and levels of rigor and for using the tagged atomic learning units for dynamically generating a curriculum for individualized academic instruction.

### BACKGROUND

Traditional approaches to education involve the student or individual completing a set of tasks associated with an academic grade and then proceeding to the tasks associated with the next grade. Curricula for academic grades are designed around textbooks, which are tied to academic standards. One problem with designing curricula around textbooks is that textbooks are out of date with respect to ever changing standards. Further, the grade approach is not tailored to individual students and content types or courseware brands that are best suited to advance an individual student's competency with respect to a standard.

Learning management systems exist where assignments are associated with academic standards. However, because the assignments represent an agglomeration of individual academic tasks, there is no ability to assess the student's performance with respect to individual task types, media content types, or level of rigor associated with an individual academic task.

Accordingly, there exists a need for methods, systems, and computer readable media for tagging atomic learning units of instructional content with standards and levels of rigor and for using the tagged atomic learning units for dynamically generating a curriculum for individualized academic instruction.

### SUMMARY

A system for tagging atomic learning units of instructional content and for dynamically generating a curriculum tailored to an individual using the tagged units is disclosed. The system includes a tagging module for tagging atomic learning units of instructional content with at least one standard and at least one level of rigor to form learning objects. The system further includes a learning objects database for storing the learning objects. The system further includes a dynamic curriculum generation module for dynamically generating a curriculum tailored to an individual by selecting individual learning objects from the database using the tags and for presenting the curriculum to the individual.

As used herein, the term “atomic learning unit” refers to in individual unit of instructional content, such as a math question.

The term “standard” refers to an approved or accepted model for evaluating a curriculum or tasks within a curriculum. Examples of standards include instructional design standards, curriculum standards, grade level standards, and chronological age level standards. Standards may be issued by state or federal government agencies, by private entities, or by standards setting organizations. Examples of specific standards that may be used to tag atomic learning units include the Common Core State Standards, the Texas Essential Knowledge Standards (TEKS), etc.

The term “level of rigor” refers to a metric of the degree that an atomic learning unit assesses competency with respect to a particular standard. The level of rigor may be a numeric value or an alphanumeric descriptor. In one exemplary implementation of the subject matter described herein, levels of rigor 1-4 correspond to descriptors “knowledge,” “reasoning,” “demonstrate,” and “produce,” each of which will be described in more detail below.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with respect to the accompanying drawings, of which:

FIG. 1 is a block diagram of an exemplary system for tagging atomic learning units of instructional content with standards and levels of rigor and using the tagged atomic learning units for dynamically generating a curriculum for individualized academic instruction according to an embodiment of the subject matter described herein;

FIGS. 2A and 2B are computer screen shots of an example of an atomic learning unit and the tagging of the atomic learning unit with multiple levels of rigor and multiple standards according to an embodiment of the subject matter described herein;

FIG. 2C is a computer screen shot of a standards tagging interface according to an embodiment of the subject matter described herein;

FIG. 3 is a diagram illustrating the same atomic learning unit being tagged with different standards and levels of rigor to form different learning objects according to an embodiment of the subject matter described herein;

FIGS. 4A and 4B are computer screen shots of another example of an atomic learning unit and the tagging of the atomic learning unit with multiple standards and levels of rigor according to an embodiment of the subject matter described herein;

FIGS. 5A and 5B are additional examples of an atomic learning unit and the tagging of the atomic learning unit with multiple standards and levels of rigor according to an embodiment of the subject matter described herein;

FIG. 6 is a flow chart of exemplary overall steps of a method for tagging learning units of instructional content with standards and levels of rigor and using the tagged atomic learning units for dynamically generating a curriculum for individualized academic instruction according to an embodiment of the subject matter described herein;

FIG. 7A is a flow chart illustrating the use of tagged atomic learning units to dynamically generate an individualized curriculum according to an embodiment of the subject matter described herein;

FIG. 7B is a computer screen shot illustrating an example of an instructional atomic learning unit according to an embodiment of the subject matter described herein;

FIG. 7C is a computer screen shot illustrating an example of an assessment atomic learning unit according to an embodiment of the subject matter described herein;

FIG. 8 is a flow chart illustrating the use of tagged atomic learning units to dynamically generate a curriculum tailored to a particular content presentation type for an individual according to an embodiment of the subject matter described herein; and

FIG. 9 is a flow chart illustrating the use of tagged atomic learning units to dynamically generate a curriculum tailored to a particular courseware brand for an individual according to an embodiment of the subject matter described herein.

### DETAILED DESCRIPTION

The subject matter described herein includes methods, systems, and computer readable media for tagging atomic learning units of instructional content with standards and levels of rigor and for using the tagged atomic learning units for dynamically generating a curriculum for individualized academic instruction. FIG. 1 is a block diagram illustrating an exemplary system for tagging atomic learning units of instructional content and for dynamically generating a curriculum tailored to an individual using the tagged units. Referring to FIG. 1, exemplary components that may be used to implement the system include a computing platform 100, an administrative terminal 102, and student terminals 104 and 106. Each of platform 100 and terminals 102, 104, and 106 may include one or more microprocessors, memory, and network communication capabilities. In one implementation, computing platform 100 may be a server and student terminals 104 and 106 may be fixed or mobile communications devices that include clients capable of accessing individualized academic curricula generated by components of computing platform 100, which will now be described.

In the illustrated example, computing platform 100 includes a tagging module 108, a dynamic curriculum generation module 110, a standards database 112, and a learning objects database 114. Tagging module 108 allows an administrator to tag atomic learning units stored in learning objects database 114 with levels of rigor and with standards from standards database 112. The administrator may access or invoke tagging module 108 to tag the atomic learning units through administrative terminal 102 via a client interface, such as a web browser. As stated above, an atomic learning unit is an individual unit of instructional content, such as a math or language question. A single atomic learning unit may be tagged with multiple different standards and multiple different levels of rigor, resulting in different learning objects. Examples of atomic learning units, standards, and levels of rigor will be discussed in more detail below. Dynamic curriculum generation module 110 dynamically generates curricula tailored to individuals by selecting individual learning objects from the database using the tags and for presenting the curricula to the individuals, for example, via student terminals 104 and 106.

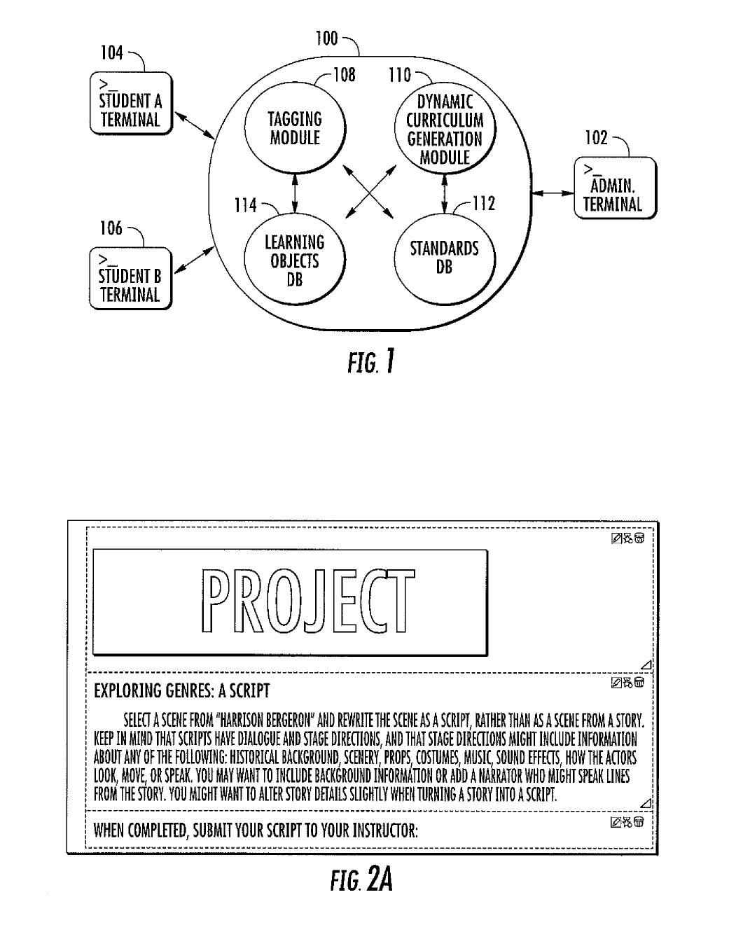

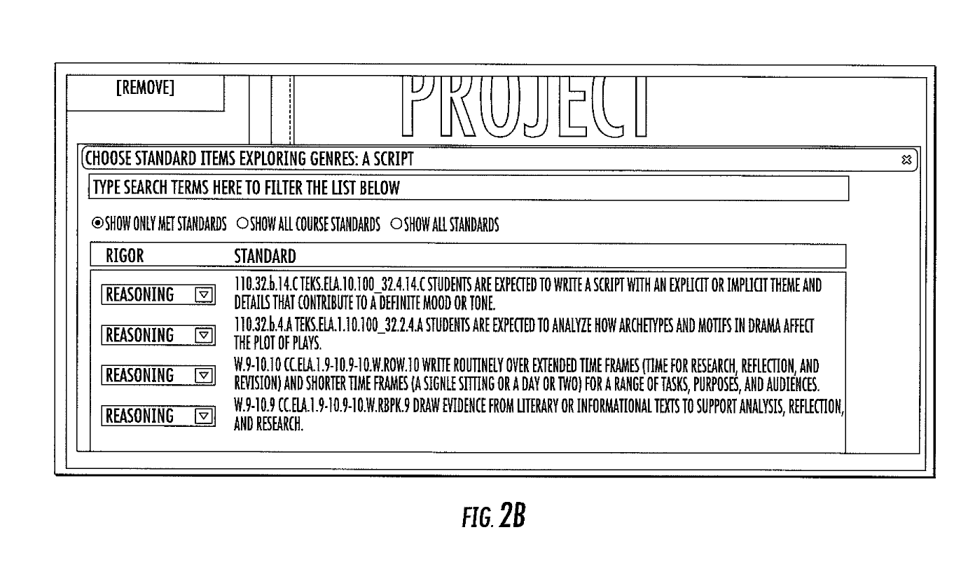

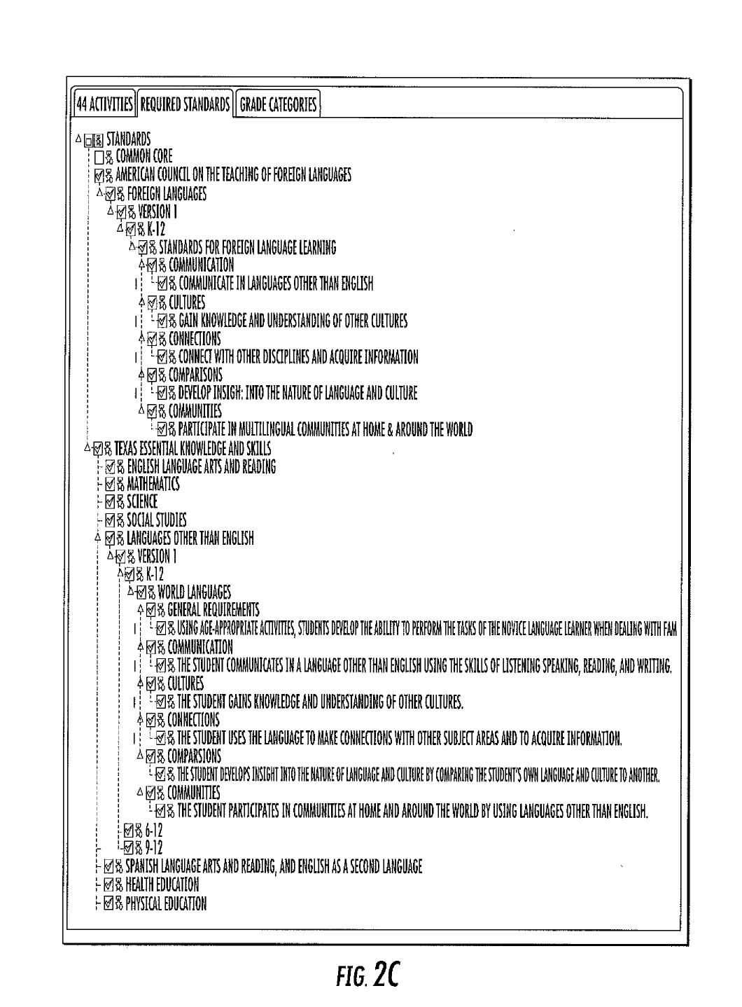

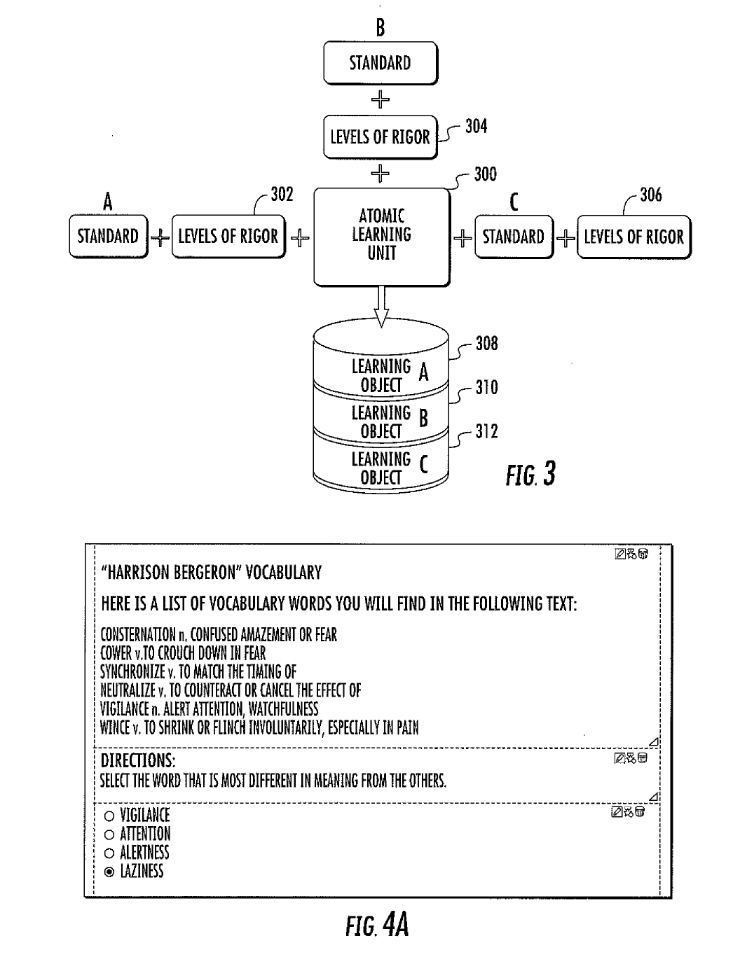

FIG. 2A is one example of an atomic learning unit. In FIG. 2A, the atomic learning unit is a literature activity where the student is requested to select a scene from the science fiction story, “Harrison Bergeron” by Kurt Vonnegut and rewrite the scene as a script. FIG. 2B is an example of tagging the atomic learning unit in FIG. 2A with multiple standards and multiple levels of rigor. In FIG. 2B, tagging module 108 displays the standards that are associated with the atomic learning unit illustrated in FIG. 2A. In the illustrated example, the standards are identified by standards codes. The parameters in the codes include parameter values that identify the standards setting organization, the topic, the grade level, the category, subcategory, and other parameters. For example, “TEKS” in the codes identifies the Texas Essential Knowledge Standards. A drop down menu is associated with each standard where the administrator is allowed to select a level of rigor to associate with each standard. Table 1 shown below illustrates examples of levels of rigor that may be selected.

TABLE 1
Examples and Descriptions of Levels of Rigor

| Content Levels | Content Target | Description |
|---|---|---|
| Level of Rigor 1 | Knowledge | Recall and Reproduction, |
| | | Remembering |
| Level of Rigor 2 | Reasoning | Skills and Concepts, Comprehension, |
| | | Understanding |
| Level of Rigor 3 | Demonstrate | Strategic Thinking, Applying, |
| | | Analyzing |
| Level of Rigor 4 | Produce | Extended Thinking, Evaluating, |
| | | Creating |

The levels of rigor in Table 1 may be based on commonly accepted terms as used in industry approved taxonomies. In Table 1 levels of rigor 1-4 correspond to knowledge, reasoning, demonstrate, and produce. Level of rigor 1, knowledge, means that the activity is intended to test the student's ability to recall, remember, or reproduce something about the activity. Level of rigor 2, reasoning, means that the activity is intended to test the student's understanding of concepts associated with the activity. Level of rigor 3, demonstrate, means that the activity is intended to test the student's ability to analyze or think about the activity. Level of rigor 4, produce, means that the activity is intended to test the student's ability to think and produce creatively about the activity. As illustrated in FIG. 2B, the same activity or atomic learning unit can be associated with administration-defined and different levels of rigor.

In addition to tagging atomic learning units with levels of rigor, tagging module 108 may also provide an interface for a user to tag atomic learning units with standards. FIG. 2C is a computer screen shot illustrating an example of a graphical user interface that may be presented by tagging module 108 to allow an administrator to select standards to associate with an atomic learning unit. In FIG. 2C, the standards are displayed in a tree structure for easy identification of the relevant organization, subject, version, grade, category and subcategory of standard. In FIG. 2C, the standards are organized by standards setting organization as the topmost category. Within each standards setting organization, the standards are organized by subject, version, and grade. Within each grade or group of grades, the standards grouped in categories and subcategories. For each subcategory, the interface includes a description associated with standards that are or should be within the subcategory. For example, for the cultures subcategory, the interface displays, “The student gains knowledge and understanding of other cultures.” Similar descriptions are included with other categories.

To tag an atomic learning unit with a standard, tagging module 108 may allow the administrator to drag and drop a graphical representation of an atomic learning unit into the appropriate subcategory in the tree structure illustrated in FIG. 2C. Alternatively, tagging module 108 may display the tree structure illustrated in FIG. 2C as a drop down menu when the administrator is viewing an atomic learning unit, for example, from the screen illustrated in FIG. 2A or 2B.

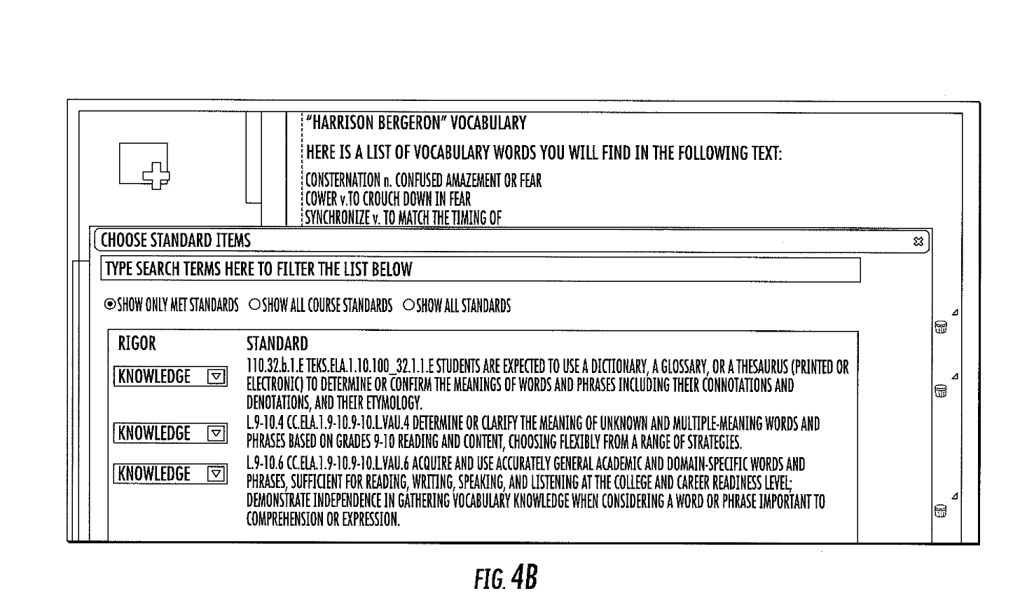

Each combination of a level of rigor, an atomic learning unit, and a standard forms a learning object that is stored in learning objects database 114. Learning objects database 114 may also store untagged atomic learning units. FIG. 3 illustrates the concept of tagging the same atomic learning unit with multiple levels of rigor and multiple different standards. In FIG. 3, the same atomic learning unit 300 is tagged with standards A, B, and C and levels of rigor 302, 304, and 306 and creates three separate learning objects 308, 310, and 312.

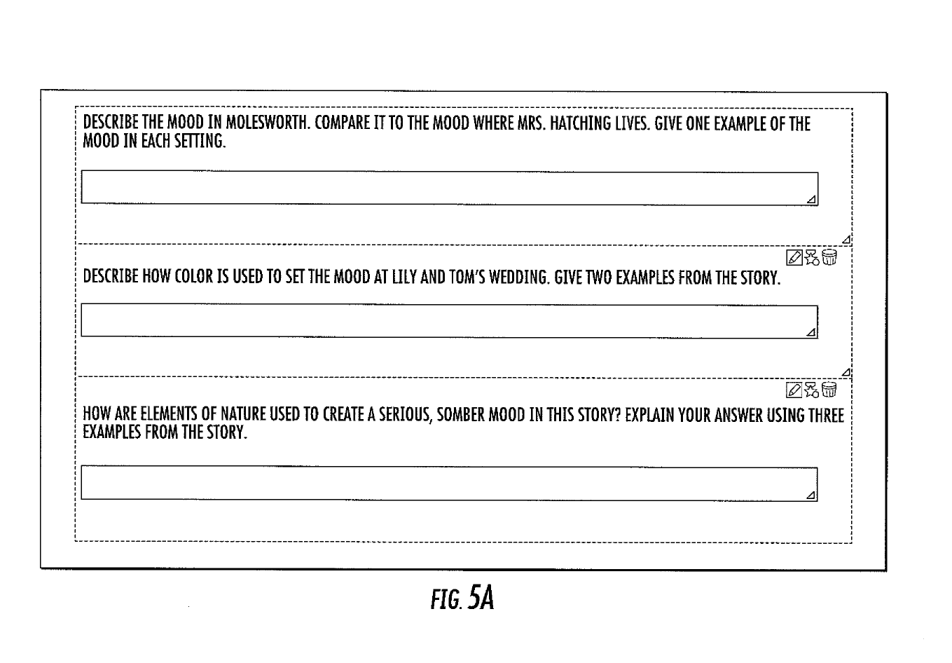

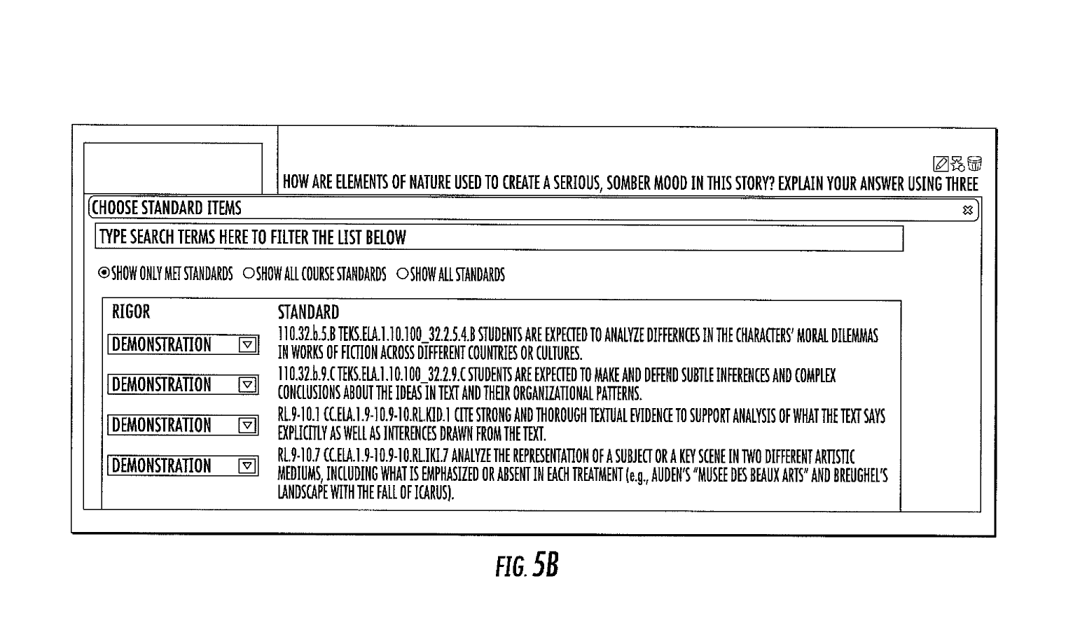

FIGS. 4A and 4B illustrate an additional example of an atomic learning unit and the tagging of the atomic learning unit with standards and levels of rigor according to an embodiment of the subject matter described herein. Continuing with the “Harrison Bergeron” example, in FIG. 4A the atomic learning unit includes a list of vocabulary words and definitions from the story, and in the lower part of the screen, an exercise for the student to select the word that is most different from the others. In FIG. 4B, standards met by the atomic learning unit in FIG. 4A are illustrated. Also, the administrator is permitted to select a level of rigor associated with each atomic learning unit-standard combination.

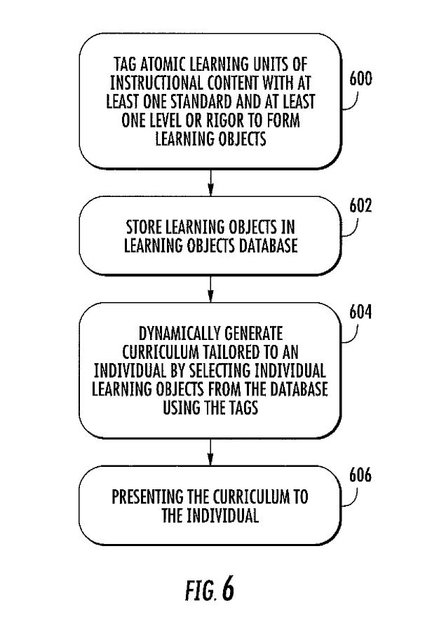

FIGS. 5A and 5B illustrate an additional example of an atomic learning unit and the tagging of the atomic learning unit with different standards and levels of rigor according to an embodiment of the subject matter described herein. In FIG. 5A, the atomic learning unit includes three questions associated with the short story “Searching for Summer” by Joan Aiken. In FIG. 5B, standards met by the questions in FIG. 5A are illustrated. In addition, the administrator is presented with menus to select a level of rigor associated with each standard-atomic learning unit combination.

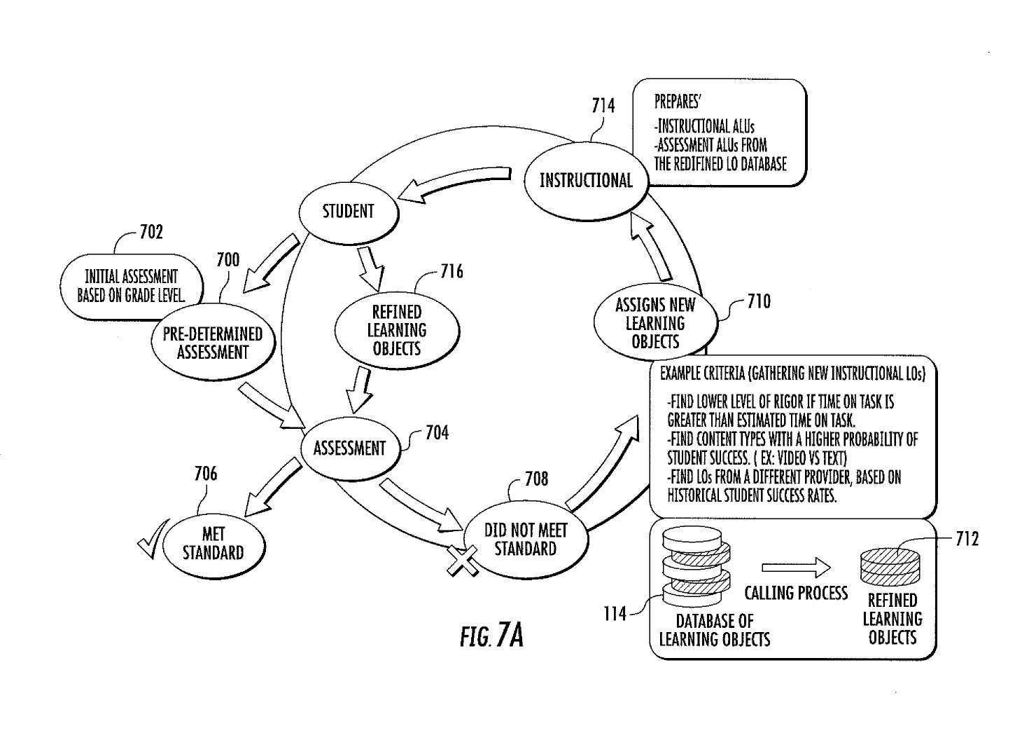

FIG. 6 is a flow chart illustrating exemplary overall steps for tagging atomic learning units of instructional content with standards and levels of rigor and for using the tag that the atomic learning unit for dynamically generating a curriculum for individualized academic instruction. Referring to FIG. 6, in steps 600, atomic learning units of instructional content are tagged with at least one standard and at least one level of rigor to form learning objects. For example, tagging module 108 may allow an administrator, using administrator terminal 102, to tag atomic learning units, such as individual academic questions, with standards and levels of rigor. In step 602, the learning objects are stored in learning objects database 114. For example, the tagged atomic learning units that form the learning objects can be stored in learning objects database 114. In step 604, a curriculum that is tailored to an individual is dynamically generated by selecting individual learning objects from the database using the tags. For example, dynamic curriculum generation module 110 may dynamically generate a curriculum tailored to a particular student based on the tags assigned to the learning objects and the performance of the student after an initial assessment, which will be described in more detail below. In step 606, the curriculum is presented to the individual. For example, dynamic curriculum generation module 110 may present a curriculum tailored to student A via student A terminal 104.

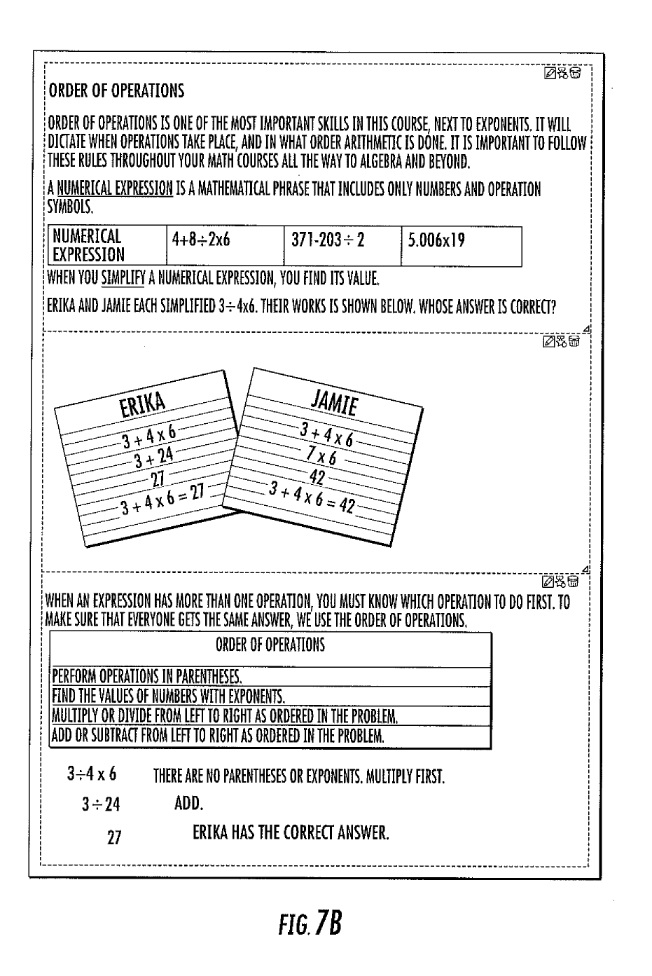

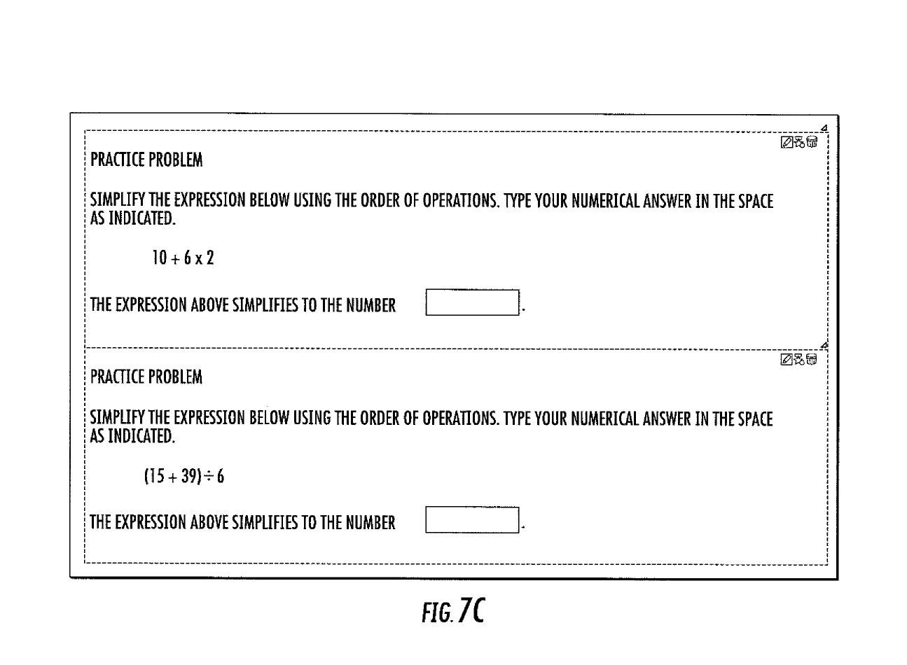

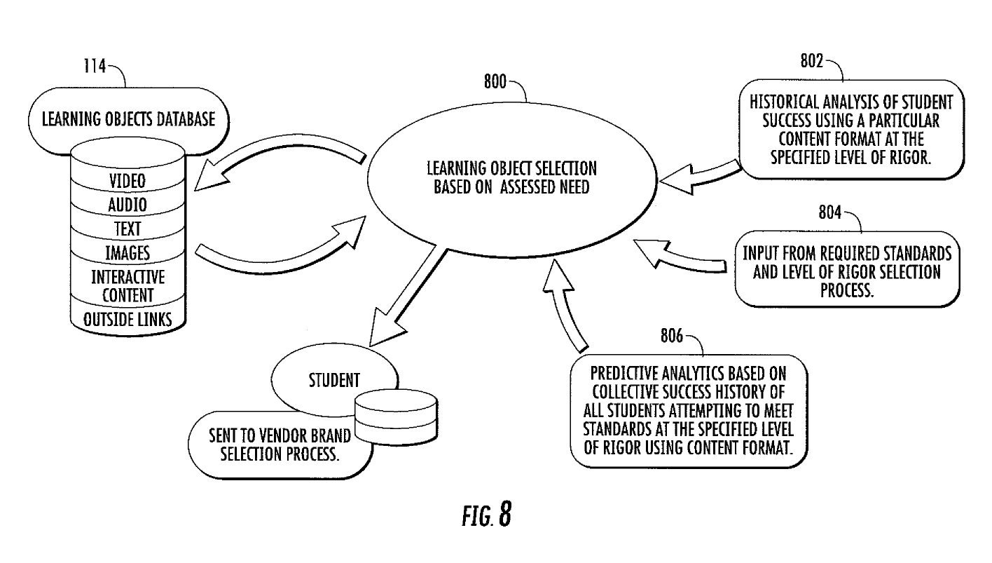

FIG. 7A is a flow chart illustrating exemplary steps for generating an individualized curriculum using learning objects according to an embodiment of the subject matter described herein. The steps illustrated in FIG. 7A may be implemented by dynamic curriculum generation module 110. Referring to FIG. 7A, in step 704, a student is given an assessment. The first assessment may be an initial assessment based on based on grade level that is constructed in steps 700 and 702. The initial assessment may involve presenting the student with individual learning objects having atomic learning units that are tailored to standards associated with a particular grade level. After the initial assessment, it is determined in steps 706 and 708 whether or not the student met the standard. If the student met the standard in step 706, the process ends. If the student did not meet the standard, control proceeds to step 710 and the new learning objects are assigned. New learning objects may be selected by dynamic curriculum generation module 110 based on the following criteria:
Find lower levels of rigor if the time on task is greater than the estimated time on task.
Find content types with a higher probability of student success (e.g., video vs. text).
Find learning objects from a different provider based on historical student success rate.

The learning objects may be selected from learning objects database 114 to produce refined learning objects 712. “Refined learning objects” refers to learning objects that are selected based on the individual's performance on previous sets of learning objects, the performance of other students, administrator preferences, etc. . . . . For example, if an individual's performance is advanced by learning objects from a particular vendor or content presentation type, learning objects in database 114 from the particular vendor or having the particular content presentation type will be selected with higher selection priority or probability in subsequent learning object selection rounds. In step 714, dynamic curriculum generation module 110 prepares instructional atomic learning units and assessment atomic learning units from refined learning objects 712. FIGS. 7B and 7C respectively illustrate examples of an instructional atomic learning unit and an assessment atomic learning unit according to embodiments of the subject matter described herein. As illustrated in FIG. 7B, an instructional atomic learning unit presents information that instructs a student regarding an educational concept, such as order of operation in mathematics. In FIG. 7C, an assessment atomic learning unit presents questions to the user that assess the user's competency in the educational concept.

Returning to FIG. 7A, once the instructional and assessment ALUs have been selected, refined learning objects are prepared in step 716 to form a new assessment tailored based on the individual's performance in the previous assessment or assessments. The process then repeats beginning with step 704 where the individual is presented with the new assessment generated from the refined learning objects. Thus, during each iteration of the learning objects selection process illustrated in FIG. 7A, learning objects are refined based on a student's performance in a previous iteration, and the refined learning objects are presented to the student, resulting in curricula that are tailored to advance the student's performance with respect to a particular standard or standards.

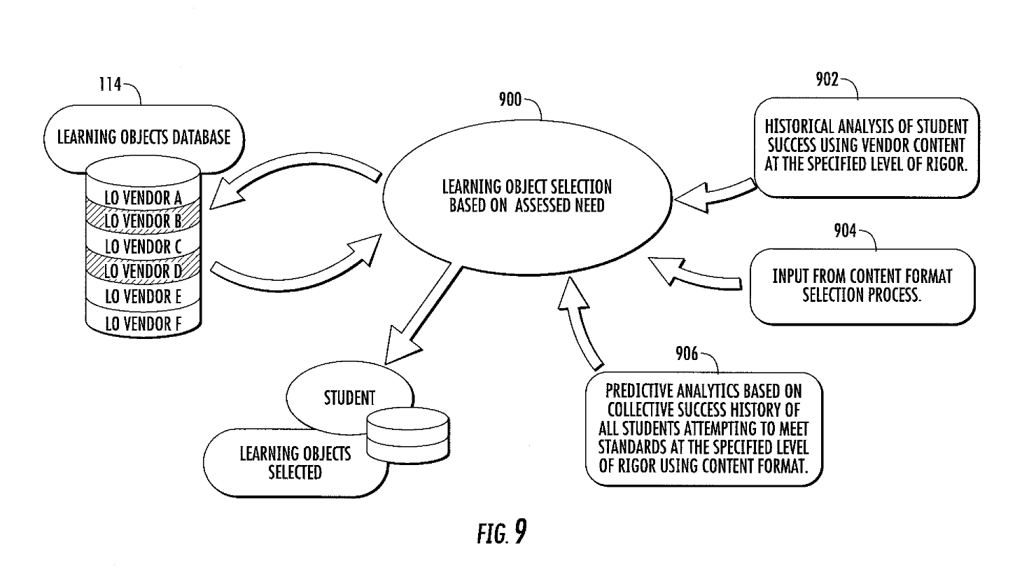

One aspect of iteratively selecting learning objects that best advance an individual's competency with respect to a standard includes considering the content presentation type associated with each learning object. As used herein, the term “content presentation type” refers to the medium in which a learning object is presented to the user. Examples of content presentation types include video, audio, text, images, interactive content, and outside links. “Outside links” refers to HTTP URLs that reference content outside of learning objects database 114. For example, an outside link for a geography course may link directly to the website of a particular country. Once created, the outside links may be stored in learning objects database 114. FIG. 8 is a flow chart illustrating the selection of a learning object and content presentation type based on an assessed need of the student. The steps illustrated in FIG. 8 may be performed by a dynamic curriculum generation module 110. Referring to FIG. 8, in step 800, a learning object or objects are selected based on the student need. The learning objects may be selected by dynamic curriculum generation module 110 from learning objects database 114. Inputs to the learning objects selection process may include historical analysis 802 of student success using a particular content format at the specified level of rigor. For example, if a student performs best with video content and level of rigor 4, then, during the learning objects selection process for this student, dynamic curriculum generation module 110 would assign a higher selection probability or weight to an atomic learning unit of video content at level of rigor 4. An additional input to the learning objects selection process is input 804 from required standards or level of rigor selection process illustrated in FIG. 7A. For example, if the selection process illustrated FIG. 7A produces learning objects that are refined for a particular user, the refined learning objects may be weighted higher than the unrefined learning objects in the learning objects selection process. An additional input to the learning objects selection process includes predictive analytics 806. Predictive analytics 806 may be based on the collective history of all students attempting to meet standards at the specified level of rigor using a particular content format. For example, if a particular learning object works well in advancing the competency of all students, that learning object may be weighted higher according to its success rate relative to other learning objects in advancing students' competency.

Additional factors that may be used to weight learning objects with selection probabilities for use in the learning objects selection process may include instructor preference, organizational preference, cost considerations (between expensive and inexpensive courseware), additional standards that may be met by the atomic learning unit (in a predictive model where presenting a student with a particular atomic learning unit will teach multiple concepts or meet multiple standards across multiple disciplines), and location during assessment (at home, at school, or at a learning facility). Once the weights or selection probabilities have been assigned to the atomic learning units, dynamic curriculum generation module 100 uses the weights in selecting learning objects 114 having atomic learning units to be presented to the student in the next assessment.

In addition to considering the content presentation type or format in selecting the learning objects having atomic learning units to be presented to a student, dynamic curriculum generation module 110 may also consider the courseware brand of the most likely to result in success for a particular student. As used herein, the term “courseware brand” refers to the source or vendor from which an atomic learning unit originates. FIG. 9 is a flow chart illustrating the use of courseware brand in the learning objects selection process. The steps illustrated in FIG. 9 may be performed by dynamic curriculum generation module 110. Referring to FIG. 9, in step 900, the learning objects selection process selects a learning object or objects from database 114 based on an assessed need of the student. One input to the brand based learning objects selection process is historical analysis 902. Historical analysis 902 may include an analysis of the student success using particular vendor content at a specified level or rigor. For example, if a student has historically performed well with the learning object vendor B at specified level or rigor 3, atomic learning units from vendor B with level of rigor 3 may be given a high selection weighting to be used in the learning objects selection process. An additional input that may be used by the learning objects selection process provided is input 904 from the content format selection process illustrated in FIG. 8. For example, it may be determined that in FIG. 8 that the student learns best with video format learning objects. According, video learning objects may be given a higher weight in the learning objects selection. Yet another input that may be provided to the learning objects selection process is predictive analytics 906. Predictive analytics 906 may be based on the collective success history of all students attempting to meet the particular standards at the level of rigor using the vendor content or courseware being evaluated. For example, if students perform better with a particular brand of courseware, atomic learning units from the vendor's courseware may be weighted with higher selection probabilities than atomic learning units from courseware where students performed poorly.

As stated above, the level of rigor may be used to assess a student's performance with a standard and to select learning objects having atomic learning units to be presented to the student in subsequent iterations of the assessment process. For example, if a student is struggling with “text based content” questions at a level of rigor 3, the level of rigor may be considered along with the content presentation type, courseware brand, and other factors to iteratively select learning objects having atomic learning units to be presented to a student. If a student is struggling with a question from a particular brand of courseware, but performs better on a similar question with another brand of courseware, the level of rigor can be used to assess not only if the student's performance is courseware related, but also to present more challenging questions if atomic learning units exist from a courseware provider in whose materials the student performs better. The level of rigor may be used to challenge the student with questions of with more advanced levels of rigor based on predictively assessing how the student will respond to instructional atomic learning units or learning objects from different content types.

It will be understood that various details of the presently disclosed subject matter may be changed without departing from the scope of the presently disclosed subject matter. Furthermore, the foregoing description is for the purpose of illustration only, and not for the purpose of limitation.

1. A system for tagging atomic learning units of instructional content and for dynamically generating a curriculum tailored to an individual using the tagged units, the system comprising:
a tagging module for tagging atomic learning units of instructional content with at least one standard and at least one level of rigor to form learning objects;
a learning objects database for storing the learning objects; and
a dynamic curriculum generation module for dynamically generating a curriculum tailored to an individual by selecting individual learning objects from the database using the tags and presenting the curriculum to the individual, wherein the dynamic curriculum generation module is configured to weight learning objects with selection probabilities for the individual relative to the individual's historical performance in a courseware brand associated with each learning object and to use the selection probabilities in selecting the new learning objects to be presented to the individual so that a particular courseware brand that has historically advanced the individual's performance with respect to a standard will be selected with higher selection probabilities than selection probabilities assigned to other courseware brands, wherein the individual is a student, the standard is an educational standard, and the historical performance is determined based on a historical analysis of success of the student using the courseware brand at a specified level of rigor.

2. The system of claim 1 wherein at least some of the atomic learning units are tagged with multiple different levels of rigor.

3. The system of claim 1 wherein at least some of the atomic learning units are tagged with multiple different standards.

4. The system of claim 1 wherein a single atomic learning unit is tagged with multiple different standards and different levels of rigor to form a plurality of different learning objects, which are stored in the learning objects database.

5. The system of claim 1 wherein the dynamic curriculum generation module is configured to track performance of the individual by content presentation type and to use the levels of rigor to dynamically assess which content presentation type should be applied to the individual to advance competency within a particular standard.

6. The system of claim 1 wherein the dynamic curriculum generation module is configured to assess performance of the individual with respect to different learning objects and to iteratively select, based on the performance, new learning objects from the learning objects database having atomic learning units to be presented to the individual.

7. The system of claim 6 wherein the dynamic curriculum generation module is configured to weight learning objects with selection probabilities for the individual relative to the individual's performance in a content presentation type associated with each learning object and to use the selection probabilities in selecting the new learning objects.

8. (canceled)

9. The system of claim 6 wherein the dynamic curriculum generation module is configured to utilize predictive analytics to weight learning objects with selection probabilities based on historical performance of all students attempting to meet one of the standards and to use the selection probabilities in selecting the new learning objects.

10. The system of claim 6 wherein the dynamic curriculum generation module is configured to consider, when selecting new learning objects having atomic learning units to be presented to the individual during an iteration, time on task of the individual with respect to the learning objects having atomic learning units presented to the individual during a previous iteration.

11. The system of claim 1 wherein the dynamic curriculum generation module is configured to track performance of the individual by courseware brand and to use levels of rigor to dynamically assess which of the courseware brands should be applied to the individual to advance competency within a particular standard.

12. A method for tagging atomic learning units of instructional content and for dynamically generating a curriculum tailored to an individual using the tagged units, the method comprising:
tagging atomic learning units of learning instructional content with at least one standard and at least one rigor to form learning objects;
storing the learning objects in a learning objects database;
dynamically generating a curriculum tailored to an individual by selecting individual learning from the database using the tags, wherein dynamically generating the curriculum comprises weighting learning objects with a selection probability for the individual relative to the individual's historical performance in a courseware brand associated with each learning object so that a particular courseware brand that has historically advanced the individual's performance with respect to a standard will be selected with higher selection probabilities than selection probabilities assigned to other courseware brands, wherein the individual is a student, the standard is an educational standard, and the historical performance is determined based on a historical analysis of success of the student using the courseware brand at a specified level of rigor; and
presenting the curriculum to the individual.

13. The method of claim 12 wherein tagging the atomic learning units includes tagging at least some of the atomic learning units with multiple different levels of rigor.

14. The method of claim 12 wherein tagging the atomic learning units includes tagging at least some of the atomic learning units with multiple different standards.

15. The method of claim 12 wherein a single atomic learning unit is tagged with multiple different standards and different levels of rigor to form a plurality of different learning objects, which are stored in the learning objects database.

16. The method of claim 12 wherein dynamically generating the curriculum comprises tracking the performance of the individual by content presentation type and using the levels of rigor to dynamically assess which content presentation type should be applied to the individual to advance competency of the individual within a particular standard.

17. The method of claim 12 wherein dynamically generating the curriculum includes assessing performance of the individual with respect to different learning objects and iteratively selecting, based on the performance, new learning objects from the learning objects database having atomic learning units to be presented to the individual.

18. The method of claim 17 wherein dynamically generating the curriculum includes weighting learning objects with selection probabilities for the individual relative to the individual's performance in a content presentation type associated with each learning object and using the selection probabilities in selecting the new learning objects.

19. (canceled)

20. The method of claim 17 wherein dynamically generating the curriculum includes utilizing predictive analytics to weight learning objects with selection probabilities based on historical performance of all students attempting to meet one of the standards and using the selection probabilities in selecting the new learning objects.

21. The method of claim 17 wherein dynamically generating the curriculum includes considering, when selecting new learning objects having atomic learning units to be presented to the individual during an iteration, time on task of the individual with respect to the learning objects having atomic learning units presented to the individual during a previous iteration.

22. The method of claim 12 wherein dynamically generating the curriculum comprises tracking the performance of the individual by courseware brand and using levels or rigor to dynamically assess which of the courseware brands should be applied to the individual to advance competency within a particular standard.

23. (canceled)

24. The method of claim 12 wherein dynamically generating the curriculum comprises using predictive analytics to weight learning objects with selection probabilities based on historical performance of all students attempting to meet one of the standards.

25. A non-transitory computer readable medium having stored thereon executable instructions that were executed by the processor of a computer control the computer performs steps comprising;
tagging atomic learning units of learning instructional content with at least one standard and at least one rigor to form learning objects;
storing the learning objects in the database;
dynamically generating a curriculum tailored to an individual by selecting individual learning from the database using the tags, wherein dynamically generating the curriculum comprises weighting learning objects with a selection probability for the individual relative to the individual's historical performance in a courseware brand associated with each learning object so that a particular courseware brand that has historically advanced the individual's performance with respect to a standard will be selected with higher selection probabilities than selection probabilities assigned to other courseware brands, wherein the individual is a student, the standard is an educational standard, and the historical performance is determined based on a historical analysis of success of the student using the courseware brand at a specified level of rigor; and
presenting the curriculum to the individual.
